(19) United States
(12) Patent Application Publication
(10) Pub. No.: US 2023/0349155 A1
(43) Pub. Date: Nov. 2, 2023

(54) LAMINATED BEAM SLAB AND PREPARATION METHOD THEREOF

(71) Applicant: Fujian University of Technology, Fuzhou (CN)

(72) Inventors: Wei ZHANG, Fuzhou (CN); Yiqun HUANG, Fuzhou (CN); Xiang LIU, Fuzhou (CN)

(21) Appl. No.: 18/125,196

(22) Filed: Mar. 23, 2023

(30) Foreign Application Priority Data
Apr. 27, 2022 (CN) 202210459539.8

(51) Int. Cl. E04C 3/26; E04C 5/08; E04C 5/06

(52) U.S. Cl. CPC E04C 3/26; E04C 5/08; E04C 5/0604

(57) ABSTRACT

Disclosed are a laminated beam slab and a preparation method thereof, belonging to the technical field of building structures. The laminated beam slab includes an intermediate layer, where the intermediate layer has protective layers arranged on both upper and lower sides, and the intermediate layer and the protective layers are provided with reinforcing cages inside; partition plates are arranged between the intermediate layer and an upper protective layer as well as a lower protective layer, the intermediate layer forms a mutually occluding mortise-and-tenon shape with a side opposite to the protective layers; the reinforcing cages have prestressing tendons and stirrups arranged penetrating through the partition plates in the intermediate layer and the protective layers; the preparation method includes steps of: prefabricating partition plates; binding reinforcing cages; installing formworks; fixing the reinforcing cages; and casting an intermediate layer and protective layers.

### CROSS-REFERENCE TO RELATED APPLICATIONS

This application claims priority to Chinese Patent Application No. 202210459539.8, filed on Apr. 27, 2022, the contents of which are hereby incorporated by reference.

### TECHNICAL FIELD

The present application belongs to the technical field of building structures, and in particular to a laminated beam slab and a preparation method thereof.

### BACKGROUND

A laminated beam slab is shaped in two pours of concrete, the first being made in the precast yard and the second being poured on the construction site, followed by integration into the whole; or the second being poured into a complete precast beam slab after the first concrete pour has set, the present application belongs to the latter.

As society develops, the requirements on construction become increasingly restrictive and buildings are rapidly developed towards larger spans, requiring laminated beams or slabs to meet the requirements of large spans and good durability. However, the existing solutions for large spans are mainly through the use of high quality concrete or the use of steel structures, both of which result in extremely high construction costs.

### SUMMARY

The present application provides a laminated beam slab and a preparation method thereof, aiming at solving the technical problem of high construction cost of large span beam slabs in the prior art.

In order to achieve the above objectives, the technical schemes adopted by the present application are as follows:

a laminated beam slab, including an intermediate layer and protective layers arranged above and below the intermediate layer, where the intermediate layer and the protective layers are provided with reinforcing cages inside; partition plates are arranged between the intermediate layer and an upper protective layer as well as between the intermediate layer and a lower protective layer, where the partition plates are laid in an undulating pattern between the intermediate layer and the protective layers; the intermediate layer matches a shape of the partition plates on both sides against the protective layers, forming a mutually occluding mortise-and-tenon shape; the reinforcing cages have prestressing tendons and stirrups arranged penetrating through the partition plates in the intermediate layer and the protective layers.

Optionally, the reinforcing cages include main reinforcements, prestressing tendons and stirrups, where the main reinforcements are longitudinally arranged along a length direction of the laminated beam slab, and the main reinforcements are arranged in plural and are in parallel arrangement respectively in the upper and the lower protective layers; the prestressing tendons are arranged in parallel with the main reinforcements; the stirrups are wrapped outside the main reinforcements and the prestressing tendons and are arranged penetrating the partition plates; and the stirrups are arranged in plural spaced along a length direction of the main reinforcements.

Optionally, the intermediate layer is cast from ordinary concrete, and the protective layers are cast from ultra-high performance concrete (UHPC).

Optionally, the partition plates are profiled steel sheets, provided with waveforms including but not limited to a shape of trapezoid, rectangle, sine curve or polygonal line.

Optionally, the profiled steel sheets have a crest spacing of 115, 175, 210 or 230 millimeters (mm) and a crest height of 35 or 75 mm; each prestressing tendon penetrates a center of the crest height of the profiled steel sheets.

Optionally, the prestressing tendons are fiber reinforced polymer (FRP) prestressing tendons, tensioned by a pre-tensioning method to a designed prestressing value.

Optionally, the main reinforcements are FRP reinforcements or hot-rolled ribbed bar (HRB) 400 reinforcements; and the intermediate layer is poured using ordinary concrete with strength not lower than C40.

Optionally, the stirrups are HRB400 reinforcements with a diameter of 6-8 mm, and four corners of each stirrup bind the main reinforcements arranged longitudinally; the stirrups are cast in the upper and lower protective layers and the intermediate layer.

The present application also provides a preparation method of the laminated beam slab, including steps as follows:
step 1, prefabricating partition plates, including pre-drilling reserved channels for prestressing tendons as well as stirrups on the partition plates;
step 2, binding reinforcing cages, including inserting the prestressing tendons through corresponding pre-drilled reserved channels and fixing onto a pre-tensioning prestressing table; bending the stirrups after passing through the pre-drilled reserved channels first, and finally tying longitudinal main reinforcements at top and bottom;
step 3, installing formworks, where a protective layer thickness of not less than 30 mm is left between the formworks and the reinforcing cages;
step 4, fixing the reinforcing cages, including arranging the prestressing tendons at design positions, tensioning the prestressing tendons to a designed value through the pre-tensioning prestressing table, and fixing the reinforcing cages at position; and
step 5, casting, including casting an upper protective layer and a lower protective layer using UHPC, then casting an intermediate layer using ordinary concrete, followed by smoothing and curing until reaching 75 percent (%) or more of a designed strength, then removing the formworks.

The above technical schemes have the following beneficial effects: in comparison with the prior art, the present application makes full use of the force performance of each component material by casting UHPC on the upper and lower sides of the intermediate layer to form protective layers, and the intermediate layer is less stressed by using ordinary concrete as casting material, which may greatly reduce the cross-sectional size under the same stress conditions, thus reducing the self-weight of the structure, increasing the span of the beam and reducing the cost of the project; moreover, it can be widely used in large span bending members such as precast bridge girders and precast bridge decks as well members with strict requirements for crack control.

### BRIEF DESCRIPTION OF THE DRAWINGS

The present application is further described in detail with reference to the attached drawings and specific embodiments.

FIG. 1 illustrates a structural schematic diagram illustrating a laminated beam slab provided in an embodiment of the present application.

FIG. 2 is a sectional view taken along line A-A in FIG. 1.

FIG. 3 is a sectional view taken along line B-B in FIG. 1.

FIG. 4 shows a four-point bending analysis for an isometric modelling of a laminated beam in an embodiment of the present application.

FIG. 5 shows a four-point bending analysis for an isometric modelling of a comparative model.

FIG. 6 shows a comparison of stress-strain in bottom span unit of the laminated beam in the embodiment of the present application with that of bottom span unit in the comparative model.

FIG. 7 is a processing illustrating a preparation method of the laminated beam slab provided in an embodiment of the present application.

### DETAILED DESCRIPTION OF THE EMBODIMENTS

The following provides a clear and thorough description of the technical schemes in the embodiments of the present application in conjunction with the accompanying drawings in the embodiments of the present application. It is clear that the embodiments described are only a part of the embodiments of the present application and not all of them. Based on the embodiments in the present application, all other embodiments obtained by ordinary technicians in the field without creative labor belong to the scope of protection of the present application.

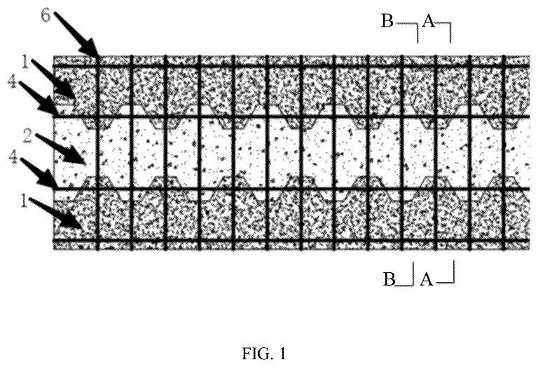

Referring to FIG. 1, a laminated beam slab provided by an embodiment of the present application includes an intermediate layer 2 and protective layers 1 arranged above and below the intermediate layer 2, where the intermediate layer 2 and the protective layers 1 are provided with reinforcing cages inside; partition plates 3 are arranged between the intermediate layer 2 and an upper protective layer 1 as well as a lower protective layer 1, where the partition plates 3 are laid in an undulating pattern between the intermediate layer 2 and the protective layers 1; the intermediate layer 2 matches a shape of the partition plates 3 on both sides against the protective layers 1, forming a mutually occluding mortise-and-tenon shape; the reinforcing cages have prestressing tendons 4 and stirrups 6 poured through the partition plates 3 in the intermediate layer 2 and the protective layers 1. During casting, the intermediate layer 2 is made of ordinary concrete, and the protective layers 1 are made of ultra-high performance concrete (UHPC).

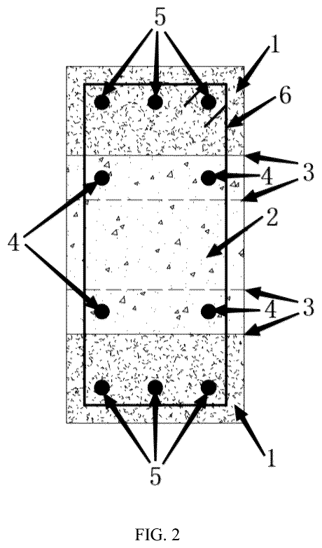

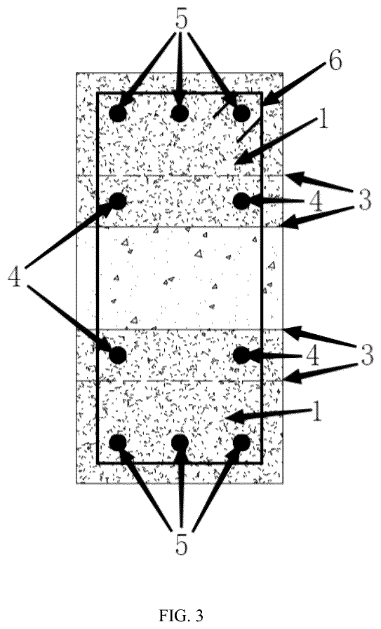

As can be seen from FIGS. 1-3, the reinforcing cages include main reinforcements 5, prestressing tendons 4 and stirrups 6, where the main reinforcements 5 are longitudinally arranged along a length direction of the laminated beam slab, and the main reinforcements 5 are arranged in plural and are arranged in parallel respectively in the protective layers 1 on the upper and lower sides; the prestressing tendons 4 are arranged in parallel with the main reinforcements 5; the stirrups 6 are wrapped outside the main reinforcements 5 and the prestressing tendons 4 and are arranged through the partition plates 3; and the stirrups 6 are arranged in parallel with each other at intervals along a length of the main reinforcements 5. This embodiment involves a laminated beam with partition plates arranged along the longitudinal direction of the beam to act as a separating formwork between the protective layers and the intermediate layer, a plurality of longitudinal main reinforcements distributed at the top and bottom of the beam and a plurality of stirrups cast into the concrete beam, running through the protective layers and intermediate layer via pre-drilled channels in the partition plates, enclosing all longitudinal reinforcements, prestressing tendons and the partition plate; the design requires arrangements in longitudinal intervals.

In one embodiment of the present application, the partition plates 3 are profiled steel sheets, provided in a waveform including but not limited to a shape of trapezoid, rectangle, sine curve or polygonal line, where the profiled steel sheets have a crest spacing of 115, 175, 210 or 230 millimeters (mm) and a crest height of 35 or 75 mm; and each prestressing tendon 4 penetrates a center of the crest height of the profiled steel sheets. The profiled steel plate is determined according to the cross-sectional dimensions of the laminated beam plate, whereas models such as YX 35-115-690, YX 35-175-700, YX 75-210-840 and YX 75-230-690 in GB/T 12755-91 can be used for the specific design.

As a preferred scheme, the prestressing tendons 4 are fiber reinforced polymer (FRP) prestressing tendons, tensioned by a pre-tensioning method to a designed prestressing value. Prestressing tendons penetrate through the protective layers 1 of UHPC concrete, the intermediate layer 2 of ordinary concrete and the partition plates 3, then pre-stressing is applied to them to tightly join the three together and ensure that the overall strength of the laminated beam meets the requirements.

In actual construction, the main reinforcements 5 are FRP reinforcements or hot-rolled ribbed bar (FIRE) 400 reinforcements, and the intermediate layers 2 are cast with ordinary concrete with strength not lower than C40; the stirrups 6 are HRB400 reinforcements with a diameter of 6-8 mm; four corners of the stirrups 6 bind the main reinforcements 5 arranged longitudinally; and the stirrups 6 are cast in the upper and lower protective layers 1 and the intermediate layer 2.

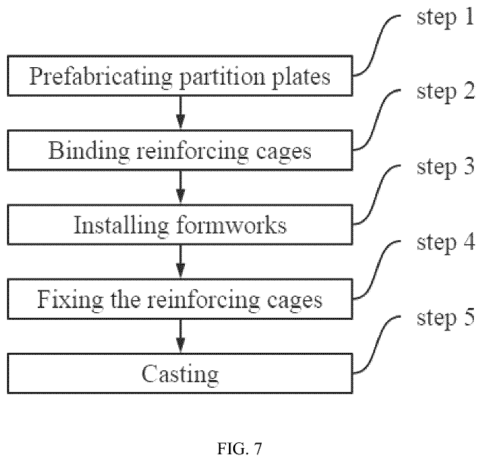

The present application also provides a preparation method of the laminated beam slab as shown in FIG. 7, including steps as follows:
step 1, prefabricating partition plates, including pre-drilling reserved channels for prestressing tendons 4 as well as stirrups 6 on the partition plates 3, where the size of the pre-drilled reserved channels for prestressing tendons is 1-2 mm slightly larger than the diameter of prestressing tendons selected in the design, and the remaining reserved channels for stirrups are reserved according to the diameter and spacing of the stirrups, with a channel size 1-2 mm slightly larger than that of the stirrups selected in the design;
step 2, binding reinforcing cages, including inserting the prestressing tendons 4 through corresponding pre-drilled reserved channels and fixing onto a pre-tensioning prestressing table; bending the stirrups 6 after passing through the pre-drilled reserved channels first, and finally tying longitudinal main reinforcements 5 at top and bottom, where the four corners of the stirrups bind the main reinforcements arranged longitudinally;
step 3, installing formworks, where a protective layer thickness of not less than 30 mm is left between the formworks and the reinforcing cages;
step 4, fixing the reinforcing cages, including arranging the prestressing tendons 4 at design positions, tensioning the prestressing tendons to a designed value through the pre-tensioning prestressing table, and fixing the reinforcing cages at position, where the prestressing tendons are fixed onto the pre-tensioning prestressing table through pre-drilled channels, with profiled steel sheets bound at the quartering points of stirrups with steel wires, and the crests and troughs of the upper and lower profiled steel sheets are arranged opposite each other; and
step 5, casting, including casting protective layers 1 of up and down using UHPC, then casting an intermediate layer 2 with ordinary concrete, followed by smoothing and curing until reaching 75 percent (%) or more of s design strength, then removing the formworks.

The laminated beam prepared according to the present application has a concrete structure as follows:

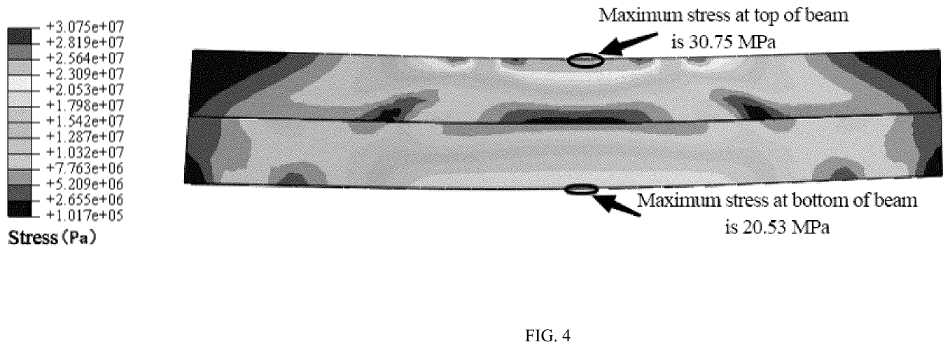

beam with section size of 600 mm*300 mm, span of 3,000 mm, protective layers of top and bottom with casting height of 150 mm and UHPC concrete, intermediate layer with thickness of 300 mm and ordinary C40 concrete, profiled steel sheets of YX75-230-690, longitudinal reinforcements of 4Φ12, stirrups of Φ8 @ 120, and the prestressing tendons with diameter of 12 mm, all of which are HRB400 reinforcements; see FIG. 4 for a four-point bending analysis of the laminated beam using the finite element analysis software Abaqus for isometric modelling.

As a comparative model, the large span flexural members used in current projects have the following specific structures:

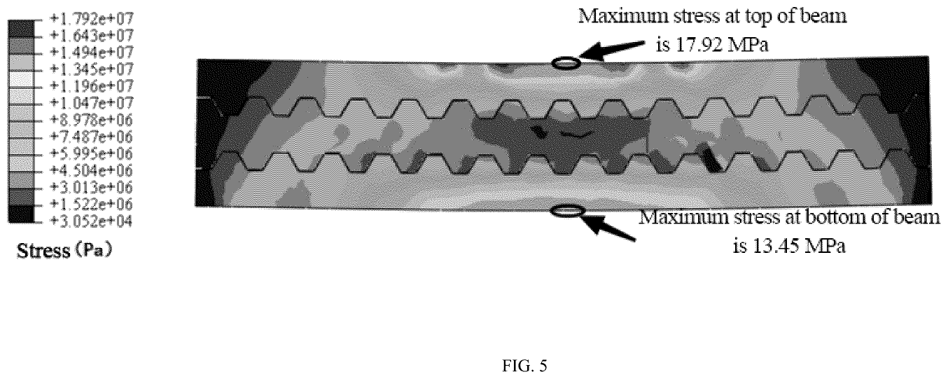

beam with section size of 600 mm*300 mm, span of 3,000 mm, protective layer of bottom with casting height of 300 mm and UHPC concrete, an upper protective layer and intermediate layer with thickness of 300 mm and ordinary C40 concrete, longitudinal reinforcements of 4Φ12, stirrups of Φ8 @ 120, and the prestressing tendons with diameter of 12 mm, all of which are HRB400 reinforcements; see FIG. 5 for a four-point bending analysis of this member using the finite element analysis software Abaqus for isometric modelling.

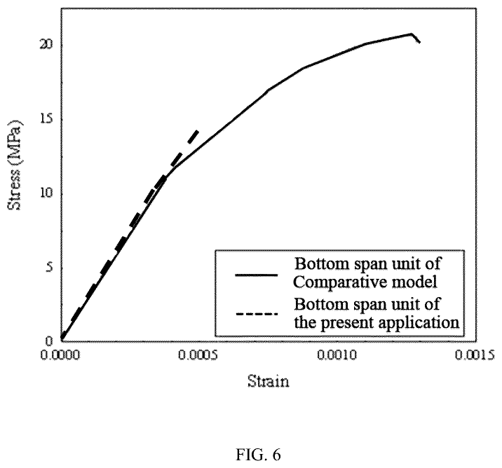

A comparison of the stress-strain in the bottom span unit of the beam prepared according to the present application with that of the comparative model is shown in FIG. 6, which indicates that the stresses in the upper and lower layers of the concrete are significantly reduced as a result of the laminated beam prepared by the present application, resulting in less cracking of the concrete and improved durability of the beam.

To sum up, the laminated beam slab provided by the present application uses UHPC concrete in the upper and lower layers where the force is strong, making full use of the excellent tensile strength, compressive strength and cracking resistance of UHPC concrete compared with that of ordinary concrete, and the use of ordinary concrete in the intermediate layer where the force is relatively small can reduce the cost of the laminated beam and enable the laminated beam to have good working performance and durability as a whole, meeting the current requirements for low cost and large span of the laminated beam. With profiled steel sheets cast between the three layers of concrete, the concrete intersection of the beams and columns forms a mutually occluding mortise-and-tenon shape, and mutual compounding of contact parts is strengthened by inserting prestressing tendons through the two kinds of concrete and profiled steel sheets, therefore ensuring the integrity and strengthening the anti-cracking performance of the structure, which further helps to reduce the cross-sectional size of the laminated beam, reduce the self-weight and better meet the engineering requirements.

Many specific details have been set out in the above description to facilitate a full understanding of the present application, but other ways of implementation of the present application different from those described herein are possible, and similar extensions can be made by those skilled in the art without contradicting the content of the present application, so that the present application is not limited by the specific embodiments disclosed above.

What is claimed is:

1. A laminated beam slab, comprising:
an intermediate layer, wherein the intermediate layer has protective layers arranged on both upper and lower sides, and the intermediate layer and the protective layers are provided with reinforcing cages inside; partition plates are arranged between the intermediate layer and an upper protective layer as well as a lower protective layer, wherein the partition plates are laid in an undulating pattern between the intermediate layer and the protective layers; the intermediate layer matches a shape of the partition plates on both sides against the protective layers, forming a mutually occluding mortise-and-tenon shape; the reinforcing cages have prestressing tendons and stirrups arranged penetrating through the partition plates in the intermediate layer and the protective layers.

2. The laminated beam slab according to claim 1, wherein the reinforcing cages comprise main reinforcements, prestressing tendons and stirrups, the main reinforcements are longitudinally arranged along a length direction of the laminated beam slab, and the main reinforcements are arranged in plural and are in parallel arrangement respectively in the protective layers on the upper and lower sides; the prestressing tendons are arranged in parallel with the main reinforcement; the stirrups are wrapped outside the main reinforcement and the prestressing tendons penetrate through the partition plates; and the stirrups are arranged in plural spaced along a length direction of the main reinforcement.

3. The laminated beam slab according to claim 1, wherein the intermediate layer is cast from ordinary concrete, and the protective layers are cast from ultra-high performance concrete.

4. The laminated beam slab according to claim 1, wherein the partition plates are profiled steel sheets, provided in a waveform including but not limited to a shape of trapezoid, rectangle, sine curve or polygonal line.

5. The laminated beam slab according to claim 4, wherein the profiled steel sheets have a crest spacing of 115, 175, 210 or 230 millimeters and a crest height of 35 or 75 millimeters; and each prestressing tendon penetrates a center of the crest height of the profiled steel sheets.

6. The laminated beam slab according to claim 2, wherein the prestressing tendons are fiber reinforced polymer prestressing tendons, tensioned by a pre-tensioning method to a designed prestressing value.

7. The laminated beam slab according to claim 2, wherein the main reinforcements are fiber reinforced polymer reinforcements or hot-rolled ribbed bar 400 reinforcements; and the intermediate layer is poured using ordinary concrete with strength not lower than C40.

8. The laminated beam slab according to claim 7, wherein the stirrups are hot-rolled ribbed bar 400 reinforcements with a diameter of 6-8 millimeters, and four corners of the stirrups bind the main reinforcements arranged longitudinally; and the stirrups are cast in the upper and lower protective layers and the intermediate layer.

9. A preparation method of the laminated beam slab according to claim 1, comprising steps as follows:
step 1, prefabricating partition plates, comprising pre-drilling reserved channels for prestressing tendons as well as stirrups in the partition plates;
step 2, binding reinforcing cages, comprising inserting the prestressing tendons through corresponding pre-drilled channels and fixing onto a pre-tensioning prestressing table; bending the stirrups after passing through the pre-drilled channels first, and finally tying longitudinal main reinforcements at a top and a bottom;
step 3, installing formworks, wherein a protective layer thickness of not less than 30 millimeters is reserved between the formworks and the reinforcing cages;
step 4, fixing the reinforcing cages, comprising arranging the prestressing tendons at design positions, tensioning the prestressing tendons to a designed value through the pre-tensioning prestressing table, and fixing the reinforcing cages at a position; and
step 5, casting, comprising casting an upper protective layer and a lower protective layer with the ultra-high performance concrete, then casting an intermediate layer with ordinary concrete, smoothing and curing until reaching 75 percent or more of s design strength, and then removing the formworks.
